(19) United States
(12) Patent Application Publication
(10) Pub. No.: US 2012/0230532 A1
(43) Pub. Date: Sep. 13, 2012

(54) Apparatus For Supporting An Earphone

(76) Inventor: Steve Howell, Indian Wells, CA (US)

(21) Appl. No.: 13/410,879

(22) Filed: Mar. 2, 2012

Related U.S. Application Data
(60) Provisional application No. 61/451,051, filed on Mar. 9, 2011.

(51) Int. Cl. H04R 1/10

(52) U.S. Cl. 381/381

(57) ABSTRACT

An apparatus and/or device for holding an earphone bud in or proximate to an ear is described. In some embodiments, the apparatus includes an ear bud support portion that supports and/or maintains an ear bud in a desired position, and an ear attachment portion that attaches the apparatus to the ear of a person wearing the apparatus.

### CROSS-REFERENCE TO RELATED APPLICATIONS

This application claims priority to U.S. Provisional Patent Application No. 61/451,051, filed on Mar. 9, 2011, entitled EARPHONE SUPPORT, which is hereby incorporated by reference in its entirety.

### BACKGROUND OF THE INVENTION

1. Field of the Invention

The invention relates generally to the field of earphones, and more specifically relates to the field of providing support to earphone devices in and/or on the ear.

2. Description of the Related Art

People wear earphones to privately listen to music, podcasts, telephone calls, and other audio information and entertainment. Ear bud type earphones have become a popular type of earphone, because they are lightweight and easy to carry when not in use, among other things. However, they suffer from various disadvantages. For example, they may contribute to ear fatigue, and they often fall out or are incorrectly positioned within an ear canal during use. For example, because they are secured to a user via the ear canal, they may not fit in a comfortable or secure manner.

Therefore, the need exists for a device that overcomes the above problems, as well as one that provides additional benefits.

### SUMMARY

An apparatus and/or device for holding an earphone bud in or proximate to an ear is described. In some embodiments, the apparatus includes an ear bud support portion that supports and/or maintains an ear bud in a desired position, and an ear attachment portion that attaches the apparatus to the ear of a person wearing the apparatus.

In some embodiments, the ear attachment portion includes a flexible, adjustable, and/or conformable ear loop that is configured to wrap around the ear and fit between the outside of a wearer's ear, or pinna, and the wearer's skull, such as near the mastoid process of the skull.

In some embodiments, the ear bud support portion includes one or more rigid interconnected pieces that rotate and/or translate with respect to one another, enabling the apparatus to rotate a supported ear bud with one or more degrees of freedom about a target ear canal. The pieces of the ear bud support portion may also, in some embodiments, include a bridge or other positioning components that are configured to facilitate a desirable positioning of the apparatus about a wearer's ear, among other benefits.

Thus, the apparatus, in some embodiments, includes components configured to support an ear bud in a desired location with respect to a target ear canal as well as components configured to comfortably and securely attach the apparatus to a wearer's ear, among other benefits.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a perspective view illustrating an earphone support device.

FIG. 2A is a perspective view illustrating an earphone support device supporting an ear bud proximate to an ear of a wearer.

FIG. 2B is a perspective view illustrating an adjustment position of an earphone support device.

FIG. 3A is a front view illustrating an ear loop portion of the earphone support device.

FIG. 3B is a side view illustrating an ear loop portion of the earphone support device.

FIG. 3C is a back view illustrating an ear loop portion of the earphone support device.

FIG. 4A is an enlarged front view illustrating an ear bud support portion of the earphone support device.

FIG. 4B is an enlarged side view illustrating an ear bud support portion of the earphone support device.

FIG. 5 is an exploded view illustrating the earphone support device.

FIG. 6A is an enlarged view illustrating a joint link of the ear bud support portion.

FIG. 6B is a side view illustrating the joint link of the ear bud support portion.

FIG. 6C is a perspective view illustrating the joint link of the ear bud support portion.

FIG. 6D is an end view illustrating the joint link of the ear bud support portion.

### DETAILED DESCRIPTION

An apparatus and/or device for supporting an earphone in or proximate to an ear of a wearer is described. In some examples, the earphone support device may be dynamically conformed to a desired shape by providing a shapeable portion that attaches the device to the wearer's ear and/or a support portion that may move in multiple angular and translational degrees of freedom to position an earphone proximate to an ear canal of the wearer's ear. That is, a conformable, repositionable earphone support device may position an ear bud or other earphone component in a manner such that a user does not experience ear fatigue and the earphone remains in place during strenuous activity, among other benefits.

For example, when used during strenuous activities (e.g., running, lifting weights), the earphone support device is able to support an ear bud in a desirable, supported position, and when used while resting or other less strenuous activities (e.g., working, commuting), a user may disengage the device from the ear bud, allowing for use of earphones without the device.

Additional embodiments and features are set forth in part in the description that follows, and in part will become apparent to those skilled in the art upon examination of the specification or may be learned by the practice of the invention.

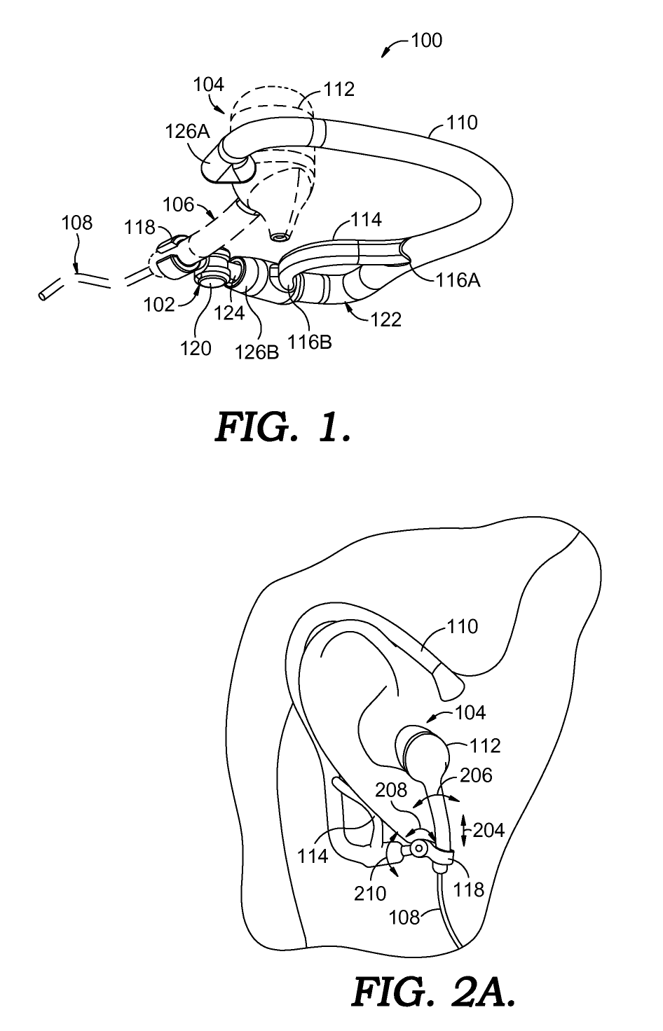

FIG. 1 is a perspective view illustrating an earphone support device 100. The earphone support device 100 includes an ear bud support portion 102 that holds an earphone 104, and an ear attachment portion 100 that attaches the device 100 to a wearer's ear. Earphone 104 includes an ear bud 112 joined with a transition portion 106 that covers a portion of earphone wire 108. Earphone 104 may be used to transmit sounds from an iPhone, iPod, cell phone, or audio player through earphone wire 108 and ear bud 112.

The earphone support device 100 includes a shapeable attachment portion 110, such as a conformable loop, and a support portion 102 that includes an elbow portion 122 and a curved bridge 114 that couples to the shapeable portion 110 near a first end 116A and couples to the elbow portion 122 near a second end 116B.

Shapeable portion 110 may be positioned between a first end point 126A of the shapeable portion 110 and the first end 116A of curved bridge 114. The elbow portion 122 is coupled to shapeable portion 110 near the first end 116A. The elbow portion 122 may be curved and form a closed loop with curved bridge 114.

In some embodiments, the elbow portion 122 is constructed of a rigid plastic, such as acrylonitrile butadiene styrene (ABS), so that structural integrity is maintained at the elbow portion 122. In general, the elbow portion 122 may be constructed of a more rigid material relative to a shape holding member 110A and sheath 110B of the loop 110 in order to provide flexibility during positioning of a supported ear bud or other earphone component.

In some embodiments, the shapeable portion 110 is flexible yet can hold its shape once positioned. For example, it may be wrapped and/or otherwise positioned around a user's ear between the user's pinna and scalp in order to comfortably fit any user's ear shape or size, among other benefits. Additionally, the flexibility of the shapeable portion 110 facilitates the easy removal from a user's ear after usage, and/or repositioning during use. For example, shapeable portion 110 may be adjusted to fit more tightly during intense activity, such as running, or to provide loose fit for less intense activity, for example, when a user sits on a chair or sofa or lies down in bed.

In some embodiments, the shapeable portion 110 includes a metal wire 110A enclosed within an exterior sheath 110B, such that the metal wire provides shape for the shapeable portion, while the exterior sheath provides comfort for wrapping around a user's ear. The shape-forming internal member 110A may be formed of steel, aluminum, copper, or alloys thereof. Of course, one of ordinary skill in the art will realize that other shape-holding metals or other materials could be used so long as the desired shape-holding properties are realized.

The internal member 110A may be bent within the exterior sheath 110B to any desired configuration, as long as it maintains sufficient rigidity that it holds and retains the sheath in the desired shape after bending. Exterior sheath 110B may be made of a bendable material capable of allowing for the bending and shape holding of internal member 110A, and in some embodiments, it is constructed of a polyvinyl chloride (PVC) material. For example, a suitable PVC material may be processed using softening agents, such that a flexible “soft” PVC results and may be used. Alternatively, the sheath 110B may be constructed of a thermoplastic elastomer (TPE). Of course, one of ordinary skill in the art will realize that the exterior sheath 110B may also be formed of other rubber-like materials, such as neoprene.

In some cases, the internal member 110A may be a solid wire. In some cases, the shape-forming internal member 110A may include other similar bendable configurations, such as multiple wires, braided wires, and so on. Additionally, in some embodiments, the shapeable portion 110 may be formed of a single material, rather than being formed of the separate shape-holding wire and sheath components, such as a material capable of being bent while maintaining a rigid shape in various different positions.

The earphone support device 100 may also include a curved bridge 114 that allows a user to place the device against the bottom of the user's ear before adjusting the shape of shapeable portion 110. That is, the bridge 114 may provide support while the shapeable portion 110 is fit into place around the ear in the area between the pinna and the scalp. Curved bridge 114 provides an ear base reference position and a structural support toward the bottom of the user's ear. Curved bridge 114 may be made of rubber to provide comfortable contact with the user's ear, among other things.

As described herein, it may be desirable for a user to be able to adjust the position of the ear bud 112 at or in the user's ear canal for optimum audio performance, such as optimum clarity of sound with reduced ambient noises. The ear bud support portion 102, therefore, is configured to facilitate such adjustability. The Ear bud support portion includes a hollow engagement portion 118 that contains an open slot 116 configured to receive and engage with the ear bud 112. Hollow engagement portion 118 may be substantially cylindrically-shaped in order to accommodate the outside surfaces of a transition portion 106 of an ear bud intended to be used, but could exist in other shapes. Hollow engagement portion 118 may have a diameter slightly smaller than an outer diameter of transition portion 106, which allows hollow portion 118 to form a firm hold of transition portion 106 of earphone 104. Transition portion 106 of earphone 104 may move up and down or rotate around central axis of transition portion 108 inside hollow portion 118 for position or angle adjustment. Thus, the ear bud 112 is afforded full translational movement along the center axis of portion 118, and also is rotatable within 360 degrees about that axis.

Open slot 116 is sized to allow earphone wire 108 to be removably attached while engaging the transition portion 106 of earphone 104 inside hollow engagement portion 118. Open slot 116 provides several functions including (a) allowing earphone wire 108 to pass through open slot 116 before sliding the transition portion 106 into portion 118 upon attaching earphone 104 to the holder assembly 102; (b) allowing transition portion 106, when ear loop 100 is in use, to translate in an axial direction or to rotate around central axis of transition portion 106 for position or angle adjustment of the ear bud 112 into a user's ear; (c) retaining the ear bud 112 firmly in position once it has been adjusted; (d) allowing earphone 104 to be easily detached from ear bud holder 102 after usage of ear loop 100, and so on.

Therefore, in some embodiments, the earphone support device 100 includes components and/or portions configured to adjust a position of a supported ear bud relative to an ear canal of a user when comfortable and securely attached to the ear of the user, among other benefits.

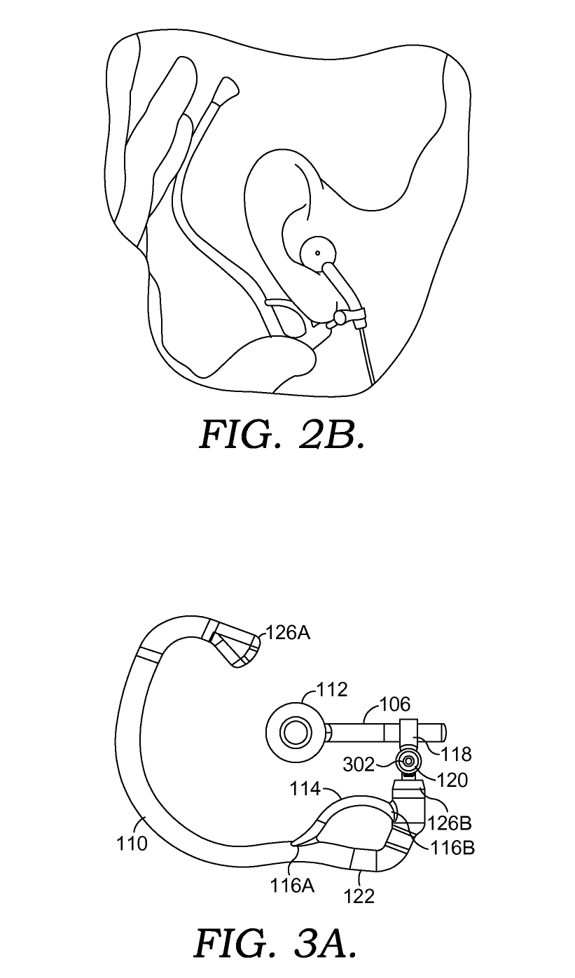

FIG. 2A is a perspective view illustrating an earphone support device 100 supporting an ear bud 112 proximate to an ear of a wearer. The bridge 114 is near bottom of the ear to position the device 100. The device enables a first degree of movement, because earphone 104 may be adjusted by moving transition portion 106 of earphone 104 up and down, as shown by arrow 204. The device enables a second degree of movement, because earphone 104 may be rotated inside holder 118, as shown by arrow 206. The device enables a third degree of movement, because earphone 104 may be repositioned relative to the ear canal, as shown by arrow 208. The device enables a fourth degree of movement, because earphone 104 may be rotated towards or away from the ear canal, as shown by arrow 210. These four adjustments enable the earphone support device 100 to position an ear bud 112 to fit into an ear canal at appropriate positions, angles, or depths.

FIG. 2B is a perspective view illustrating an adjustment position of an earphone support device. For example, the shapeable portion 110 may be moved, flexed, and/or otherwise adjusted during the attachment and/or removal of the device 100 with respect to the user's ear.

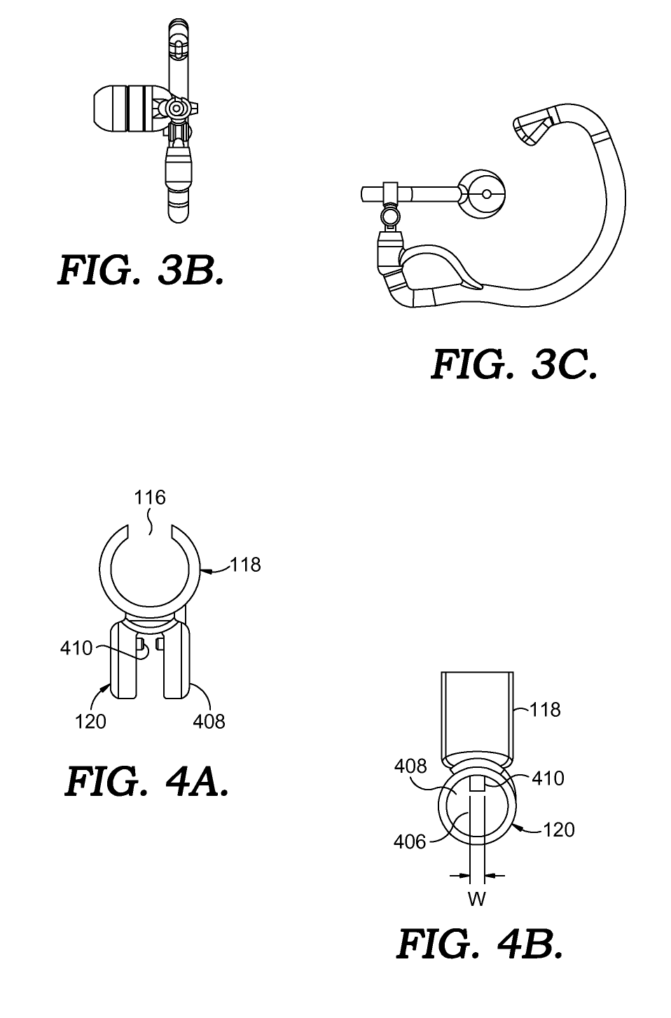

As described herein, in some embodiments, the earphone support device 100 includes a loop or conformable portion 110 configured to attach the device 100 to comfortably and securely attach the device 100 to a user's ear. FIGS. 3A, 3B, and 3C are views illustrating the ear loop portion 110 of the earphone support device 100 in more detail. The loop portion 110 is configured such that it may readily attach to the left or right ear of a wearer.

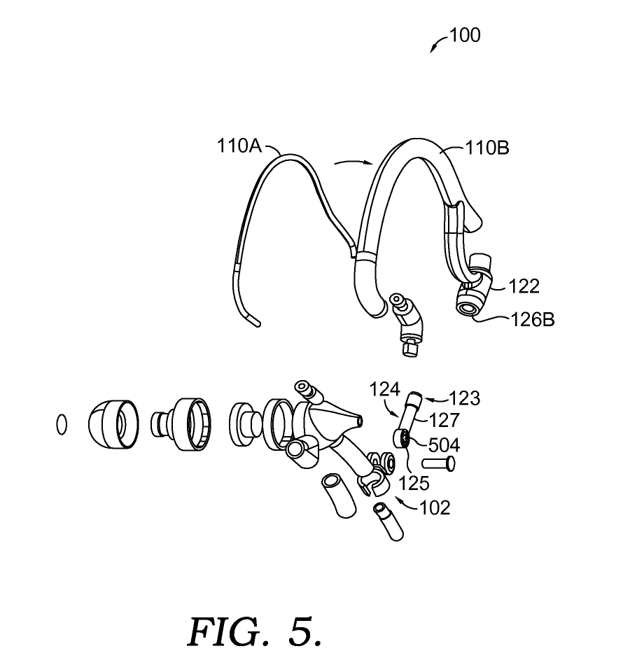

FIGS. 4A and 4B are enlarged front and side views of the earphone support portion 102. A lower portion 120 sandwiches a joint head 125 of link 124 (show in FIG. 5) that is coupled to the end of ear loop 100 near bridge 114. More specifically, lower portion 120 includes two opposing sidewalls 408, each having a hole 406 there through, as illustrated in FIG. 4B. The two sidewalls 408 are separated, generally parallel, and oppose each other. Further, sidewalls 408 may be substantially ring-shaped, as shown in FIG. 4B. Lower portion 120 also includes raised bars 410 inside each of the opposing sidewalls 408. Raised bars 410 are substantially perpendicular to the radius, and are sized to fit into radiating grooves 602 defined into both sides of the joint head 125. As the head 125 is rotated inside the walls 408, the bars 408 will snap between the proximal grooves 602 at each angular position. The bars 408 will tend to remain in the grooves 602 selected, until acted on by force from the user, at such time the ear bud holder 118 can be moved to a different angular position relative to a pin 302, which serves as an axis for the joint link 124.

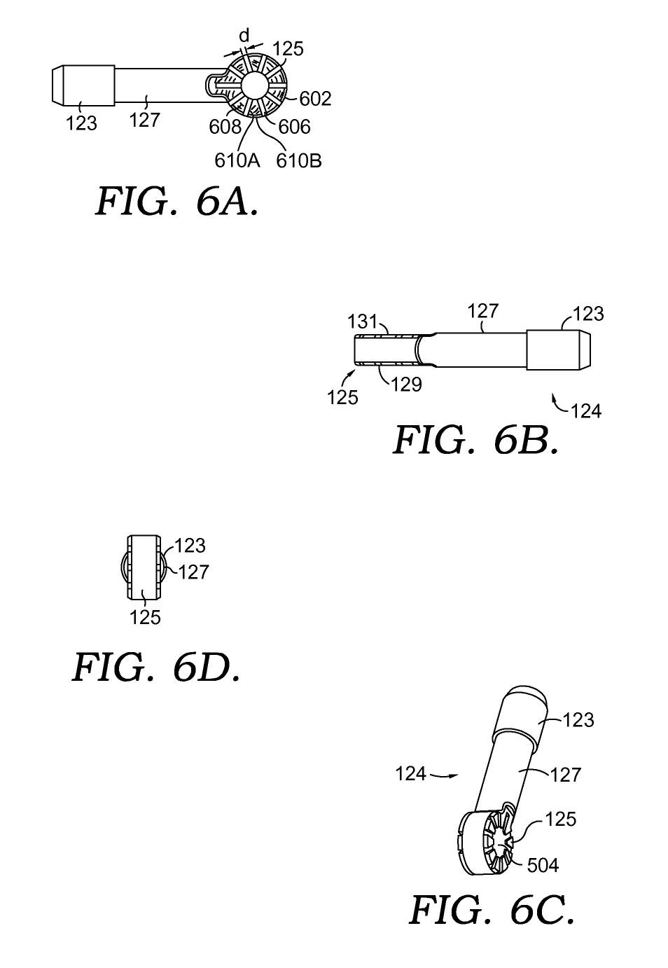

FIG. 5 is an exploded view of components of the earphone support device 100 and ear bud 112. This figure provides further illustration of how the joint head 125 of the joint link 124 is coupled to the lower portion 120 of ear bud support portion 102, and a post end 123 of joint link 124 is coupled into, and rotates axially inside (with some resistance) a socket 126B created in elbow portion 122. Joint link 124 has a substantially cylindrical main body coupled to joint head 125 and post end 123. Joint link 124 is configured to fit into two sidewalls 408 of ear bud holder 102. Pin 302 sequentially passes through first hole 406 in first sidewall 408 of ear bud holder 102, then through substantially circular opening 504 of joint link 124, and then second hole 406 of second sidewall 408 of ear bud holder 102, such that ear bud support portion 102 is coupled the loop portion 110. Again, the raised bars 410 snap into the corresponding grooves 602 on each side of the joint head 125 to lock the holder 102 into an angular position relative to the joint link 124 (see more details in FIG. 6A). Thus, the ear bud support portion 102 is rotatable and lockable around pin 302 such that the ear bud 112 may be angularly adjusted relative to ear loop 100 around the pin 302, which is substantially perpendicular to the plane of ear loop 100. Additionally, the joint link 124 is able to swivel inside the socket 126B affording yet another degree of rotation to holder 102 about the center axis of the joint link 124.

Also seen in FIG. 5 is that the metal wire 110A included inside the sheath portion 110B to create the shapeable flexibility of the ear loop 100. The sheath portion 110B may be molded with bridge 114 and elbow portion 122 as one piece, or configured according to some other manufacturing technique. Metal wire 110A can be press fit, or installed in some other fashion.

FIG. 6A is a side view illustrating the joint link of the ear bud support portion. Joint head 125 has a substantially ring-shaped main body 602 which has a center opening 504 of an inner diameter, which is substantially the same as the diameter of holes 406. Opening 504 through the joint head 125 and holes 406 of ear bud support portion 102 are close to in diameter, and create an interference fit with, the outside of the pin 302. Each joint head face has grooves 602 and protrusions 608 alternately interleaved. Each protrusion 608 is raised from the surface of grooves 602, and is substantially triangular shaped such that an edge 610A of one protrusion 608 is parallel to an opposing edge 610B of its neighboring protrusion 608. Grooves 602 are substantially rectangular shaped and have a width “d”, as illustrated. The width of grooves 602 are very close to the width of raised bars 410 on lower portion 120 of the ear bud support portion 102 to provide a locking mechanism for position. As illustrated in FIG. 6A, there are ten triangular-shaped protrusions 608 and ten grooves 602. It will be appreciated by those in the art that the number of protrusions and grooves and their locations and shapes may vary. The grooves 602 and protrusions 608 of joint head 125 are designed to match with raised bars 410 to provide a locking mechanism for angular position of ear bud holder 102 around pin 302.

FIG. 6B is a side view illustrating the joint link of the ear bud support portion. Note that both faces 129 and 131 have grooves defined in them as discussed above, and illustrated in FIG. 6A.

FIG. 6C is a perspective view illustrating the joint link of the ear bud support portion. With the locking mechanism as described and illustrated, ear bud support portion 102 or ear bud 112 may be locked at various positions to facilitate the proper placement and securement of the ear bud 112 in the user's ear canal. FIG. 6D is an end view of illustrating the joint link of the ear bud support portion showing similar details.

In some embodiments, joint link 124 and ear bud support portion 102 may be made of a plastic, such as injection-molded plastic, or some other material. In some embodiments, link 124 and ear bud support portion 102 have been constructed of ABS. The end 123 of joint link 124 may be press fit into socket 126B of the loop portion 110.

In some embodiments, the shapeable portion 110 enables the earphone support device 100 to conform to the shape of the ear to secure the ear bud. Once secured, the user is given great ranges of motion so that the ear bud can be properly placed in, or immediately outside the ear canal. Upon securement, the shapeable portion 110 creates some ability to properly locate the ear bud in various desired positions. The bridge 114 provides additional structural integrity to the loop portion 110. Next, the socket 126B/post end 123 interface creates a first degree of rotation about the common axis shared by the socket 126B and joint link 124.

In some embodiments, a second degree of angular rotation is created about axis pin 302 where the lower portion 120 of the ear bud support portion 102 rotates about the joint head 125. Again, positions in this second range of angular rotation are made lockable by the grooves 602 that receive the locking bars 410 to hold the ear bud support portion 102 in place.

In some embodiments, the device 100 facilitates a third degree of angular rotation when an ear bud is attached. Because of the fit within the hollow engagement portion 118 of the ear bud support portion 102, the transition portion 106 of the ear bud is able to rotate about its own axis. And in addition to these angular rotations, a translational movement is enabled because the transition portion 106 of the ear bud 112 is able to translate axially. Such movement, along with various rotations and translational or linear movements (taken individually or collectively), enables a user to wear the device, and therefore support an ear bud, comfortably and securely during various activities, among other benefits.

In addition to supporting ear buds and other earphone components, the device 100, in some embodiments, may be utilized and/or configured to support a variety of other audio components, such as Bluetooth headsets, hearing assistance devices, and so on.

Having described several embodiments, it will be recognized by those skilled in the art that various modifications, alternative constructions, and equivalents may be used without departing from the spirit of the invention, for example, variations in dimensions and compositions of ear loop, material selections, etc. Additionally, a number of well known processes and elements have not been described in order to avoid unnecessarily obscuring the present invention. Accordingly, the above description should not be taken as limiting the scope of the invention.

It will be understood that certain features and subcombinations are of utility and may be employed without reference to other features and subcombinations and are contemplated within the scope of the claims. Not all steps listed in the various figures need be carried out in the specific order described, and not all ranges of motion disclosed are necessary for execution of the invention.

The invention claimed is:

1. A device for securing an ear bud proximate to an ear canal of a user, the device comprising:
an ear bud support portion that includes multiple components configured to move relative to one another in order to position a supported ear bud; and
an ear attachment portion coupled to the ear bud support portion and configured to conformably attach the device to an ear of the user.

2. The device of claim 1, wherein the ear bud support portion includes:
a link having a substantially cylindrical main body and a first end received into a socket formed into ear bud support portion to create a first angular rotation about the main body of the link;
an ear bud holder; and
a pin at a second end of the link, the pin connecting the link to the ear bud holder, the pin also providing a second angular rotation about the pin, the second angular rotation being configured lockable such that the ear bud holder can be secured into a plurality of angular positions about the pin relative to the link.

3. The device of claim 1, wherein the ear bud support portion includes an ear bud holder that removably secures the supported ear bud to the ear bud support portion and is configured to enable the supported ear bud to rotate within the ear bud holder.

4. The device of claim 1, wherein the ear bud support portion includes a pin that enables the supported ear bud to rotate with respect to the ear attachment portion.

5. The device of claim 1, wherein the ear bud support portion includes:
an ear bud holder configured to enable the supported ear bud to move in a vertical direction with respect to the ear of the user.

6. The device of claim 1, wherein the ear bud support portion includes:
an ear bud holder configured to enable the supported ear bud to rotate with respect to the ear of the user.

7. The device of claim 1, wherein the ear bud support portion includes:
an ear bud holder configured to enable the supported ear bud to move in a vertical direction with respect to the ear of the user and to enable the supported ear bud to rotate with respect to the ear of the user.

8. The device of claim 1, wherein the ear bud support portion includes:
an ear bud translation component configured to enable the supported ear bud to translate towards or away from the ear of the user.

9. The device of claim 1, wherein the ear bud support portion includes:
an ear bud rotation component configured to enable the supported ear bud to rotate towards or away from the ear of the user.

10. The device of claim 1, wherein the ear bud support portion includes:
an ear bud holder configured to enable the supported ear bud to move in a vertical direction with respect to the ear of the user and to enable the supported ear bud to rotate with respect to the ear of the user; and
an ear bud translation component configured to enable the supported ear bud to translate towards or away from the ear of the user.

11. The device of claim 1, wherein the ear bud support portion includes:
an ear bud holder configured to enable the supported ear bud to move in a vertical direction with respect to the ear of the user and to enable the supported ear bud to rotate with respect to the ear of the user; and
an ear bud rotation component configured to enable the supported ear bud to rotate towards or away from the ear of the user.

12. The device of claim 1, wherein the ear bud support portion includes:
an ear bud holder configured to enable the supported ear bud to move in a vertical direction with respect to the ear of the user and to enable the supported ear bud to rotate with respect to the ear of the user;
an ear bud translation component configured to enable the supported ear bud to translate towards or away from the ear of the user; and
an ear bud rotation component configured to enable the supported ear bud to rotate towards or away from the ear of the user.

13. An earphone support for an earphone having an ear bud comprising:
a shapeable first portion which is securable to a user's ear;
a nonshapeable portion;
a link having a substantially cylindrical main body and a first end received into a socket formed into the nonshapeable portion to create a first angular rotation about the main body of the link;
an ear bud holder; and
a pin at a second end of the link, the pin connecting the link to the ear bud holder, the pin also providing a second angular rotation about the pin, the second angular rotation being configured lockable such that the ear bud holder can be secured into a plurality of angular positions about the pin relative to the link.

14. The earphone support of claim 13, wherein the ear bud holder comprises:
a receiving portion, the receiving portion adapted to allow for a third angular rotation of the ear bud relative to the ear bud holder.

15. The earphone support of claim 14, wherein the ear bud is translatable relative to the ear bud holder.

16. The earphone support of claim 13, wherein the ear bud holder allows for securement when the user engages in vigorous activities, and removal when the user is at rest.

17. An ear bud holder comprising:
a holder in which an ear bud can be secured and from which the ear bud can be removed;
a shapable loop portion for conforming to the shape of a user's ear; and,
an ear bud repositioning component that is configured to enable the ear bud to move in at least one degree of freedom relative to the loop portion into close proximity to a user's ear canal.

18. The ear bud holder of claim 17, wherein the ear bud repositioning component is configured to enable the ear bud to move in at least two degrees of freedom relative to the loop portion.

19. The ear bud holder of claim 17, wherein the ear bud repositioning component is configured to enable the ear bud to move in at least three degrees of freedom relative to the loop portion.

20. The ear bud holder of claim 17, wherein the ear bud repositioning component is configured to enable the ear bud to rotate relative to the loop portion.

21. The ear bud holder of claim 17, wherein the ear bud repositioning component is configured to enable the ear bud to translate relative to the loop portion.
